(19) United States
(12) Patent Application Publication
(10) Pub. No.: US 2006/0156848 A1
(43) Pub. Date: Jul. 20, 2006

(54) Manual simulation interface

(75) Inventors: Florian Gosselin, Vanves (FR); Tanguy Jouan-De-Kervenoael, Neauphle le Chateau (FR); Christine Megard, Franklin (FR)

Correspondence Address: PEARNE & GORDON LLP, 1801 EAST 9TH STREET, SUITE 1200, CLEVELAND, OH, 44114-3108, US

(73) Assignee: Commissariat A L'Energie Atomique, Paris 15eme (FR)

(21) Appl. No.: 10/541,631

(22) PCT Filed: Dec. 15, 2003
(86) PCT No.: PCT/FR03/50170

§ 371 Date: Jul. 7, 2005

(30) Foreign Application Priority Data
Jan. 13, 2003 (FR) 03/00294

(51) Int. Cl. G05G 9/047

(52) U.S. Cl. 74/471 XY

(57) ABSTRACT

The interface consists of a sleeve (1) attached around the user's forearm and a grip element (3) comprising touch-sensitive actuators (12) which press against the tips of the fingers and thumb-actuated control buttons (13). Actuators (6, 7, 11) connect the grip element (3) to the sleeve (1) and allow to move the latter in a noticeable manner in response to impulses from the environment, and the sleeve has a wireless displacement sensor. Hence, in the best embodiments of the invention, the user avails of two very different means both for giving commands (buttons 13 and sensor 14) and for receiving a response from the virtual environment (actuators 6, 7 and 11 and the touch-sensitive actuators 12). This interface is light and easy to use. It can be used to explore virtual environments for, visiting a location, entertainment, educational purposes, et cetera.

The subject of the invention is a manual simulation interface contemplated above all as a connection with a virtual environment, that the user wears around the forearm and that enables him both to give certain commands whist receiving, in accordance with the simulated environment, diverse touch sensations in response.

Prior documents of the art that reveal such interfaces presented in the form of a handle or a grip element that the user holds are patents U.S. Pat. Nos. 4,795,296 and 5,577,417. The applications of such interfaces are numerous and comprise virtual visits, simulation games, learning, etc. The user buried in the virtual environment must be able to act by certain actions and feel their effects, which necessitates the use of convenient and relatively elaborate interfaces to allow for diversified exchanges with the environment. Most known interfaces are too simplistic to allow for more than basic exchanges, which dampens the interest in virtual environments and hinders their development.

An essential advantage of the interface according to the invention is that it comprises two completely different methods of reaction to express the accomplishment of actions of different types. It becomes possible to distinguish, in response to the operator's action, between force feedback on the one hand, namely associated with a grasp, and reactions to more delicate actions associated with touch-sensitive recognition. The simulation interface is characterised in that it comprises a sleeve attached to one of a user's wrists and a grip element positioned in front of one of the user's hands, the grip element is mounted to the sleeve by displacement actuators, and the grip element has touch-sensitive actuators in front of the fingers of the hand, the displacement and touch-sensitive actuators being controlled by motors sensitive to simulation response impulses. A rod may replace the sleeve; it then allows to hold the interface with the user's other hand. It may also be attached to the sleeve to hold the grip element.

The introduction of varied actions by the interface is also an appreciable advantage, that may be obtained in special but privileged forms of the invention: thus, the grip element may comprise a portion close to the sleeve, fitted with at least one thumb-actuated control button; or even the sleeve (or the rod) may be fitted with a wireless displacement sensor, of which the movements are located in the immediate environment.

It is further appropriate that this interface, and especially its mobile parts, worn by the user, should remain light. It is hence advantageous that the displacement actuator control motors are positioned on the sleeve (or the rod) rather than on the mobile grip element that they move.

The affluence of the reaction sensations further depends on the number of possible movements that can be inflicted on the grip element. Advantageously, the displacement actuators control displacements in different, essentially perpendicular, directions, two of the displacement actuators being positioned between opposite side edges of the grip element and a support portion associated with the sleeve. The grip element is thus very mobile; it is even movable in all directions if it comprises a transverse rod mounted on said two actuators, which control displacements in directions perpendicular to one another and inclined in relation to the rod, and a third displacement actuator is disposed between the transverse rod and a main portion of the grip element by slidably moving the main portion on the rod.

More complex links between the sleeve and the grip element are possible.

The invention will now be described according to the following figures:

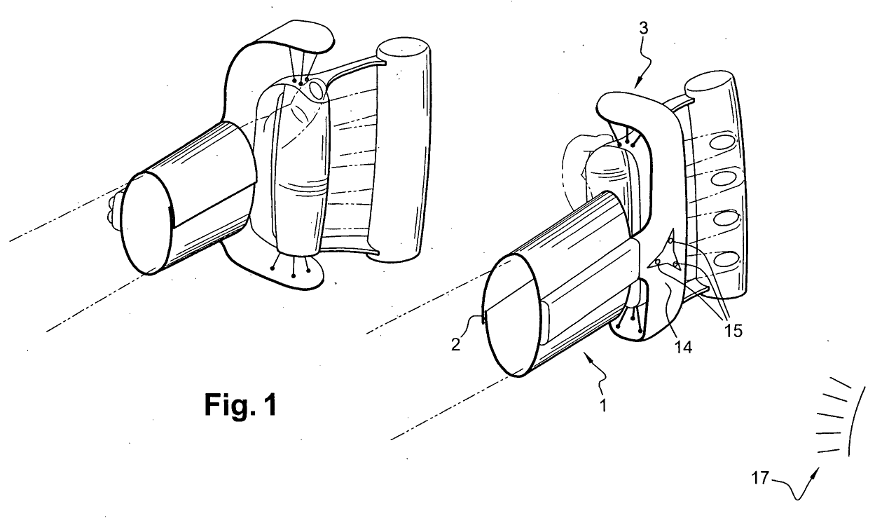

FIG. 1 is a general view of a realization of the interface,

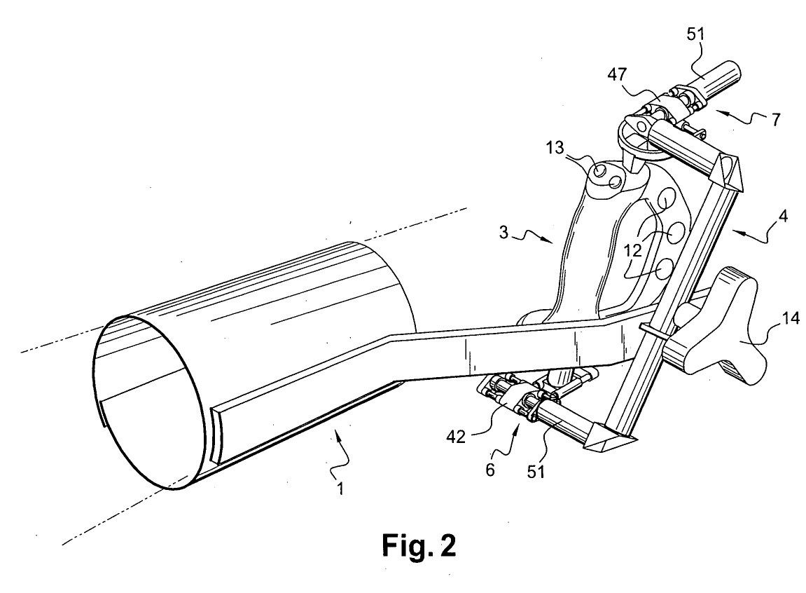

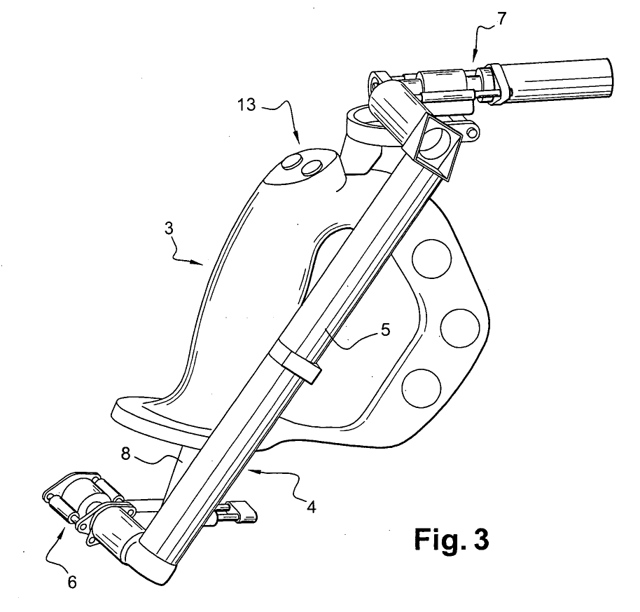

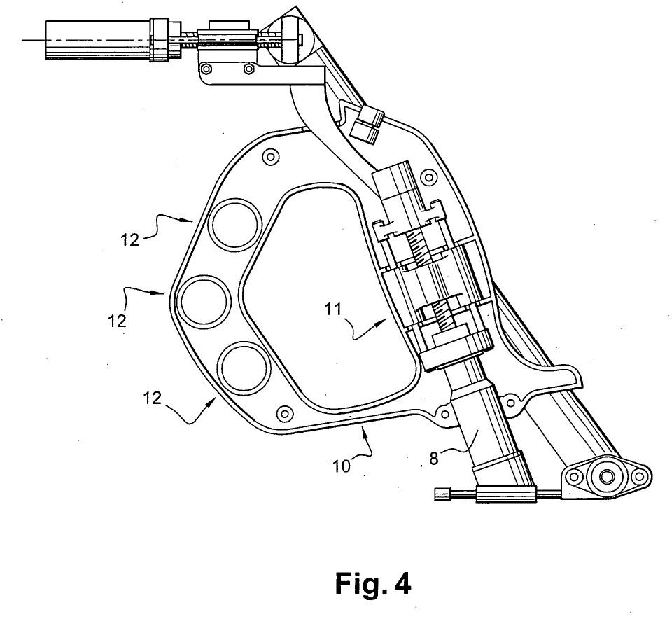

FIGS. 2, 3, 4 and 5 are specific views,

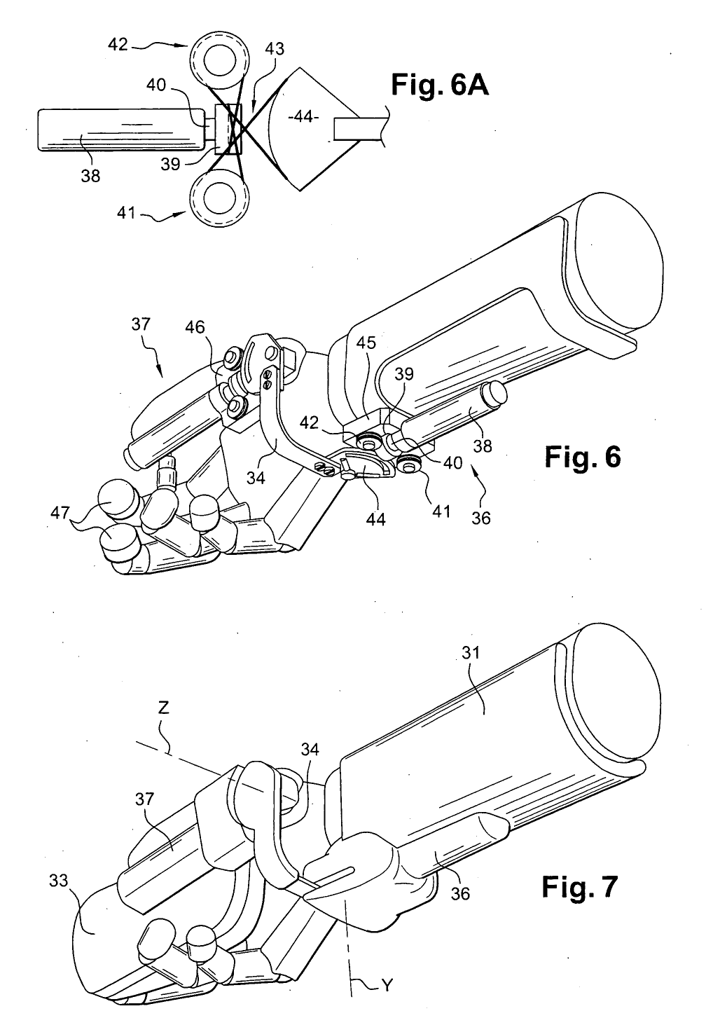

and FIGS. 6, 6A and 7 are views of another realization,

The interface of FIG. 1 comprises a sleeve 1 consisting of a strap that the user attaches around the wrist, for example by overlaying edges 2 covered with a clinging material or by any other equivalent means, and a grip element 3 extending in front of the user's hand.

The grip element 1 has a double role of support and, in this realization, of indication of the user's movement. The sleeve 1 supports the grip element 3 by means of a frame 4 that essentially consists of a rod 5 extending next to the grip element 3. In the realization shown in FIGS. 2 to 4, the rod 5 holds two linear actuators 6 and 7 at its opposite ends, for example with a screw and nut fixture, which are oriented in two directions perpendicular to one another. These two directions are strongly inclined in relation to a rod 8 along which the grip element 3 is slidable and which is connected by its ends to X-Y tables 41 and 42 allowing for translational displacement of said rod in two directions by the motors 51.

The rod 8 extends through a hollow of a main portion 10 of the grip element 3, and this hollow third actuator 11 is accommodated in this hollow. It is formed integrally with the main portion 10 and slides along the rod 8, again by a screw and nut mechanism. The rod 8 has a non-circular section to perpetuate the rotation of the main portion 10, into which it slides.

The movements of the displacement actuators 6, 7 and 11, move the main portion 10 of the grip element, held by the user, in the essentially perpendicular directions of the space according to movements similar to translations or experienced as such by the user. It is thus possible to simulate various reactions of the virtual environment in a complex manner through combination of these translations. Another means by which the reactions of the environment may be transmitted to the user consists in touch-sensitive actuators 12, of which the number is preferably between one and four and which are disposed on a crown of the main portion 10, at the areas in which the user places the ends of his or her fingers. The touch-sensitive actuators consist of miniature vibrators which are products available on the market. Some models can be adjusted in intensity or even in the direction of vibration to give more detailed sensations. Loud-speaker motors may further by used. The distance between the body of the grip element 3 and the crown supporting the actuators 12, shown in a fixed and schematic manner in the figures, can be adjustable to position the touch-sensitive actuators 12 where feeling is most enhanced.

Reactions simulated by the displacement actuators 6, 7 and 11, comprising in a known way a motor, a coder or another measuring means, can typically be forces of resistance to a pushing motion or a virtual action of the same type performed by the user; and reactions simulated by touch-sensitive actuators can be contacts on virtual objects or other actions without force applied by the user; or even changes in the state of virtual objects. The virtual environment is supported by a central control system thereto which data is supplied by sensors that can be of very different types, of which some are located on the interface and others are located elsewhere. It regulates the displacement actuators through motors, and the touch-sensitive actuators 12 by defining their reactions according to the way in which it was programmed. The virtual environments themselves are extremely varied and are not the subject of the invention.

Virtual environments are further explored by operator commands. Some may be provided by the interface referred to herein. The main portion 10 comprises at least one button 13 at the end of a straight part containing the rod 8 opposite the touch-sensitive actuators 12: this straight part of the grip element is a rest for the thumb of the operator who presses buttons 13 as soon as is necessary. Control of said buttons may be associated with a determined action in the environment, such as the grasping of a tool or of another object.

Other control means consist of a movement sensor 14 on the sleeve 1. This is an optical, magnetic or other type of sensor, which allows, using a radiation source 17 forming a fixed reference, to measure the displacements in position and in orientation of the interface in relation to the source 17. This type of sensor is well known. The movements of the interface may be converted into different actions, such as movement within the virtual environment.

Finally, it is advantageous that the sleeve 1 has displacement actuators 6 and 7. These actuators consist in a known way of a motor, an encoder and a screw and nut system. The actuator 11 is located advantageously on the rod 8 and in a hollow of the grip element 3.

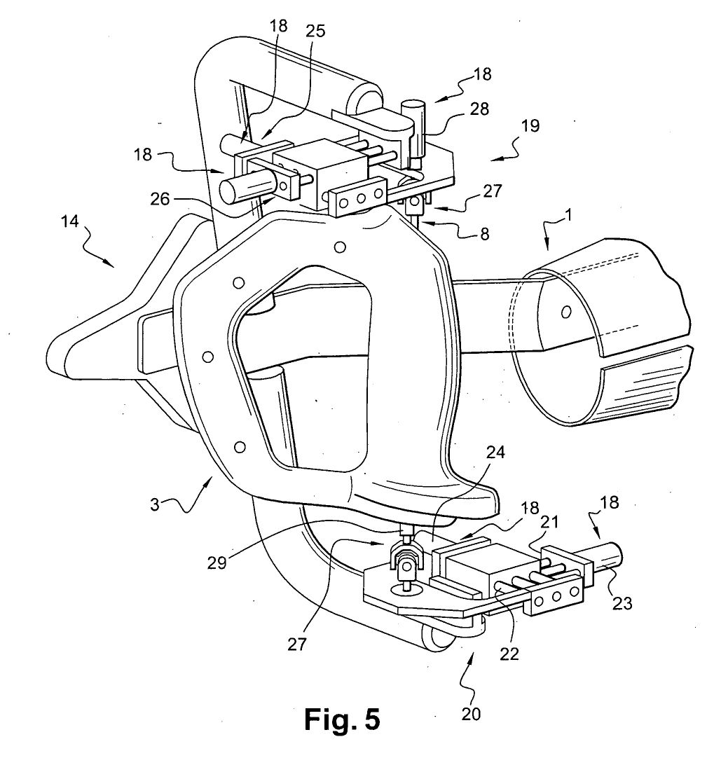

The realization shown in FIG. 5 is another form of the invention, differing at the junction between the sleeve 1 and the grip element 3 (unaltered). Six actuators are used here to provide as many degrees of displacement freedom. Six motors 18 are used to control these actuators, of which five are visible, the sixth, controlling an actuator similar to the actuator 11 on account of its function and position, being in the grip element 3.

At the top and at the bottom of the grip element 3, as previously, we find the plane movement tables (X-Y) 19 and 20 consisting of two perpendicular slideways 21 and 22 allowing to move the two ends of the grip element 3. Two actuators 23 and 24, or 25 and 26, are supported by each table 19 or 20 and control the movements on the slideways. If these movements are identical and in the same direction, pure translations of the grip element are obtained; if the directions are opposite, pure rotations are obtained. The grip element 3 is supported by a pair of Cardan joints 27 between the tables 19 and 20 and the ends of the rod 8, as well as a slideway 29 between the lowermost end of the rod 8 and the table 20 to adjust the space between the Cardan joints 27 integrally formed with the tables 18 and 20. A fifth actuator 28, coaxial with rod 8, rotates the latter around its axis.

The sleeve 1 may be removed: whereby the user would directly hold the rod 5 next to the grip element 3 using his or her other hand. In this instance, the command by simulation would be carried out with said other hand, which would move the interface, and the reactions would be felt by the first hand as previously.

A further example of a realization of the invention will be described by means of the last Figures, and first by FIG. 7 which represents a general view of said realization. This embodiment again comprises a sleeve 31, a grip element 33, a frame 34, and two displacement actuators 36 and 37 of which the general characteristics are identical to those of the corresponding parts 1, 3, 4, 6 and 7 already encountered. However, the displacement actuators 36 and 37 are constructed in a different way such as is illustrated in FIG. 6. The screw actuators are replaced by cable actuators of a unique type. Each of them comprises a motor 38, a drive pulley 39 located at the end of an output shaft 40 of the motor, a pair of guide pulleys 41 and 42, a cable 43 shown in FIG. 6A, and a driven pulley 44, restricted here to one sector. The driven pulleys 44 are both linked to the frame 34, and the motors 38 of the displacement actuators 36 and 37 are respectively fixed to base plates 45 and 46 belonging to the sleeve 31 and the grip element 33 respectively.

The cable 43 is fixed at its both ends to the driven pulley 44; it is wound, between its ends, successively around the guide pulley 41, the drive pulley 39 and the other driven pulley 42. The special feature of the displacement actuators 36 and 37 is that, contrary to the customary design, the drive pulley 39 has an axis of rotation that is perpendicular to those of the guide pulleys 41 and 42 and of the driven pulley 44. It results from this arrangement, made possible by the flexibility of cable 43, to position the motors 38 alongside the user's forearm and hand, in positions in which it does not obstruct and does not cause any discomfort or any real restriction upon movement of the manual interface. Indeed, if it is true that the motors 38 are cumbersome, it is because they are slender in the direction of the extension of the output shaft 40, but thin in the transversal directions. It is advantageous to coincide this main extension direction of the motors 38 with the main directions of the user's forearm and hand.

The transmissions of the displacement actuators 36 and 37 are both positioned at the level of the user's wrist, and the frame 34 is bent at an angle such that the axes of rotation Y and Z of the driven pulleys 44 are perpendicuar to one another and extend through the wrist: the interface thus has a mobility area which coincides precisely with that of the user, such that it does not hinder his or her natural movements.

Here again the grip element is fitted with touch-sensitive actuators 47 shown schematically in FIG. 6, and of which it is to be understood that they are mounted onto the housing of the grip element 33. Said housing may also comprise other buttons, not shown, that may take the shape of pushbuttons or thumb-wheels to trigger actuations or unwinding. Equipment that could allow to locate the interface in space and that would comprise a trihedral of spheres reflecting the light and that would be fixed to the sleeve 31 is not shown either. A camera would permanently trace the shape and the position of the trihedral on its image to deduct its position and its orientation. Such a system, although already known per se, does not belong to the invention.

1. A simulation interface, characterized in that it comprises a grip element (3) positioned in front of a user's hand, a sleeve (1) attached to a user's forearm and/or a rod (4) held by the user's other hand, the grip element is linked to the sleeve or to the rod by displacement actuators (6, 7, 11, 36, 37), and the grip element has touch-sensitive actuators (12) in front of the fingers of the hand, the displacement and touch-sensitive actuators being controlled by simulation action responses.

2. A simulation interface according to claim 1, characterised in that the grip element (3) comprises a portion (10) near to the sleeve (1) or to the rod, fitted with at least one thumb-actuated control button (13).

3. A simulation interface according to any of claims 1 or 2, characterised in that the sleeve or the rod (4) is fitted with a wireless displacement or position sensor (14) with a fixed reference.

4. A simulation interface according to claim 1, characterised in that displacement actuator control motors (16) are positioned on the sleeve.

5. A simulation interface according to claim 4, characterised in that the displacement actuators control displacements in different, essentially perpendicular directions, two of the displacement actuators (6, 7) being positioned between opposite side edges of the sleeve and a portion of the support associated with the sleeve.

6. A simulation interface according to claim 5, characterized in that the grip element comprises a transverse rod (8) mounted onto said two actuators, which control displacements in directions perpendicular to one another and inclined in relation to the rod, and a third displacement actuator is disposed between the rod and a main portion (10) of the grip element (3) by slidably moving the main portion on the rod (8).

7. A simulation interface according to claim 5, characterised in that four of the displacement actuators are positioned in pairs between displacement X-Y tables adjacent to opposite side edges of the grip element and the support portion associated with the sleeve.

8. A simulation interface according to claim 1, characterized in that the displacement actuators (36, 37), comprise a motor (38), a drive pulley (39), a driven pulley (44), and a cable transmission (43) between the drive pulley and the driven pulley, the drive pulley and the driven pulley having perpendicular axes and the motors being positioned alongside the user's forearm and hand, the driven pulley being fixed to a frame (4) between the sleeve (1) and the grip element (3), the motors (38) being fixed to the sleeve and to the grip element respectively, and the driven pulleys having axes of rotation passing through a user's wrist.
